(19) United States
(12) Patent Application Publication
(10) Pub. No.: US 2026/0313327 A1
(43) Pub. Date: Oct. 8, 2026

(54) METHODS AND APPARATUSES FOR SUPPORTING CHARGING OF A FEDERATED SERVICE

(71) Applicant: LENOVO (SINGAPORE) PTE. LTD, SINGAPORE (SG)

(72) Inventors: Emmanouil PATEROMICHELAKIS, Viersen (DE); Ishan VAISHNAVI, Munich (DE)

(21) Appl. No.: 18/998,323

(22) PCT Filed: Sep. 23, 2022
(86) PCT No.: PCT/EP2022/076557

§ 371 Date: Jan. 24, 2025

(30) Foreign Application Priority Data
Jul. 25, 2022 (GR) 20220100596

(51) Int. Cl. H04W 4/24; H04L 12/14

(52) U.S. Cl. CPC H04W 4/24; H04L 12/1407

(57) ABSTRACT

There is provided a method performed at a charging control entity of a wireless network, the method for supporting charging of a federated service, the federated service being an edge and/or cloud service offered by more than one provider, the method comprising: detecting a requirement for charging for the federated an edge service offered by more than one provider; coordinating configuration for the charging for the federated edge service; and triggering a federated service charging event based on the coordinated configuration.

### FIELD

The subject matter disclosed herein relates to a charging control entity of a wireless network and method performed thereby. In particular, the subject matter disclosed herein relates to method performed at a charging control entity of a wireless network for supporting charging of a federated service.

### BACKGROUND

In GSMA OPG.02 (URL: https://www.gsma.com/futurenetworks/wp-content/uploads/2021/07/GSMA-OPG-Telco-Edge-Requirements-2021.pdf), requirements for federated services have been proposed. A generic architecture has been provided, in which the following entities of interest are described.
Federation Manager Role: an operator platform (OP) role which includes publishing and providing access to the resources and capabilities of another OP, including its Capability Exposure Role and Service Resource Manager Role.
Federation Broker Role: an OP role in charge of easing the relationship between federated OPs. For example, the role allows an OP to access many other OPs through a single point of contact and simplify its contractual relationships. The Federation Broker Role is optional, since a federation may be performed/established directly between two Federation Managers (in a one-to-one relationship).

In 3GPP EDGEAPP (3GPP TS 23.558 v17.4.0 ), an application layer functional model for an edge enablement layer has been specified. In this architecture, the main capabilities specified relate to an Edge Enabler Server (EES), an Edge Configuration Server (ECS) and EDGE-x interfaces.

Charging for edge computing services (including EES) is specified in 3GPP TS 32.257 v17.0.1 and applies the following principles.
5GS usage for edge computing (related to 5GC).
Edge-enabling infrastructure resource usage (as per subclause 5.1.3)—the resources include the CPU/memory/disk usage and data volumes and charging information for edge-enabling infrastructure, and resource usage information is collected for each Edge Application Server (EAS) by a Charging Enablement Function (CEF) from a managed network service (MnS), with the information identifying an edge data network (EDN). Here, the edge-enabling infrastructure resources are allocated and the information indicating the collection period of the measurements related to the edge-enabling infrastructure resources usage.
Edge application server deployment (as per subclause 5.1.4)—a Capability Exposure Function (CEF) is able to consume the MnSs (as described in 3GPP TS 28.538 v17.1.0 ) to receive notifications about EAS deployment, and enable charging for the EAS deployment. The MnSs include: EAS instantiation; EAS upgrade; EAS termination (see 3GPP TS 28.538 v17.1.0 ).
Edge-enabling services usage—the charging for edge-enabling services is based on the edge application enabling functionalities specified in 3GPP TS 23.558 v17.1.0, including the services directly provided by an Edge Computing Service Provider (ECSP) to an Application Service Provider (ASP), and the 3GPP 5GC network function (NF) services indirectly exposed by the ECSP to the ASP:

The EES collects the following charging information for converged charging of edge-enabling services charging:
The charging information identifying the EAS for which the edge-enabling service is provided;
The charging information identifying the EDN in which the EAS is/was deployed;
The charging information indicating the EES which triggers said charging;
The triggering events for charging for edge-enabling services;
The charging information specific to the triggering event for charging for edge-enabling services.

The EES shall be able to perform converged charging by interacting with a Charging Function (CHF), for charging data related to the events mentioned above. A Charging Data Request and Charging Data Response are exchanged between the EES and the CHF, based on either IEC or PEC scenarios as specified in 3GPP TS 32.290 v17.5.0.

There are two variants described previously for converged charging architecture.

In a first variant, a CEF consumes the MnS from the MnS producer for EAS management (see 3GPP TS 28.538 v17.1.0 ), and determines the occurrence of charging events towards to the CHF for converged charging processing. Generation of Charging Data Records (CDR) is performed by the CHF acting as a Charging Data Function (CDF), which transfers them to a Charging Gateway Function (CGF).

Finally, the CGF creates CDR files and forwards them to the Billing Domain (BD).

If the CGF is external to the charging domain (i.e., so the CGF is not co-located with the CHF), the CHF, acting as a CDF, forwards the CDRs to the CGF across the Ga interface.

If the CGF is integrated with the 5G charging domain (i.e., so it is within the same domain as CHF), there is only one internal interface between the CHF and the CGF. In this case, the relationship between CHF and CGF is one-to-one. An integrated CGF may support the Ga interface from other CDFs.

When an external CGF is used, this CGF may also be used by other, i.e. non-5GCS, network elements, according to network design and operator decisions. It should be noted that the CGF may also be an integrated component of the BD-in this case, the Bd interface does not exist and is replaced by a proprietary solution internal to the BD.

Clause 4.2.2 of 3GPP TS 28.202 depicts architectural options for converged charging with support of an MnS producer.

### SUMMARY

Disclosed herein are procedures for provisioning edge services in federated deployments of wireless communications networks. Said procedures may be implemented by a charging control entity of a mobile network.

In an aspect, there is provided a method performed at a charging control entity of a wireless network. The method is for supporting charging of a federated service.

The federated service is an edge and/or cloud service offered by more than one provider. The method comprises: detecting a requirement for charging for the federated service; coordinating configuration for the charging for the federated service; and triggering a federated service charging event based on the coordinated configuration.

In a further aspect, there is provided a charging control entity of a wireless network. The charging control entity is arranged to provision charging of a federated service. The federated service is an edge and/or cloud service offered by more than one provider. The charging control entity comprises one or more processors arranged to: detect a requirement for charging for the federated service offered by more than one provider; coordinate configuration for the charging for the federated service; and trigger a federated service charging event based on the coordinated configuration.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for provisioning edge services in federated deployments of wireless communications networks will now be described, by way of example only, with reference to the accompanying drawings, in which:

FIG. 1 depicts a wireless communication system (not to scale) in which the methods and apparatuses disclosed herein may be implemented;

FIG. 2 depicts a GMSA OPG architecture as defined in GSMA OPG.02;

FIG. 3 depicts an application layer functional model for an edge enablement layer as described in 3GPP TS 23.558 v17.4.0;

FIG. 4 depicts a converged charging architecture with a MnS producer enabled by a CEF;

FIG. 5 depicts a further converged charging architecture with a CTF embedded in an EES;

FIG. 6 depicts relationships involved in edge computing services during federation and roaming;

FIG. 7 depicts an EAS deployed by different ECSPs, as described in 3GPP TR 23.700-98 v.1.1.1;

FIG. 8 depicts an edge node sharing scenario between a first OP and a second OP;

FIG. 9 depicts a user equipment apparatus that may be used for implementing the methods described herein;

FIG. 10 depicts a network node that may be used for implementing the methods described herein;

FIG. 11 depicts a procedure for coordinating charging in federated edge service scenarios;

FIG. 12 depicts a procedure for charging for an edge service spanning across ECSPs;

FIG. 13 depicts a procedure for charging for federated EAS Lifecycle Management (LCM);

FIG. 14 depicts a procedure for charging for an edge node sharing scenario; and

FIG. 15 is a process flow chart showing certain steps of a method performed at a charging control entity of a wireless network.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list.

For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

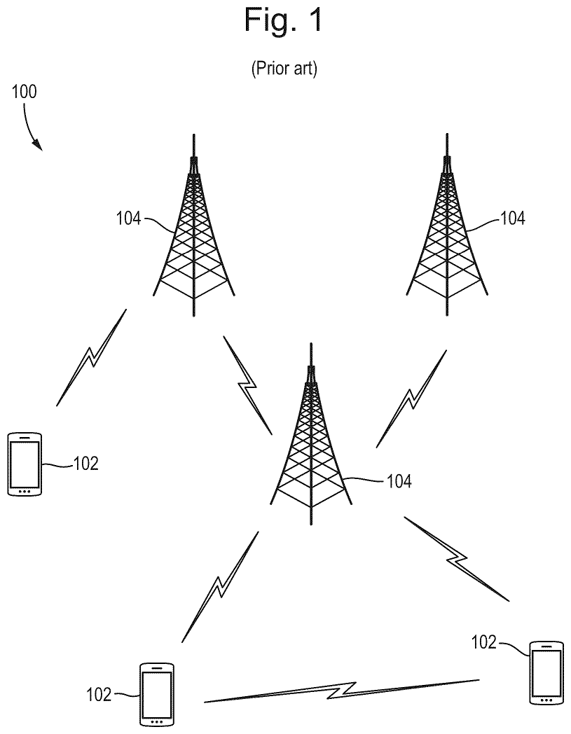

FIG. 1 depicts an embodiment of a wireless communication system 100 in which the methods and apparatuses disclosed herein may be implemented. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

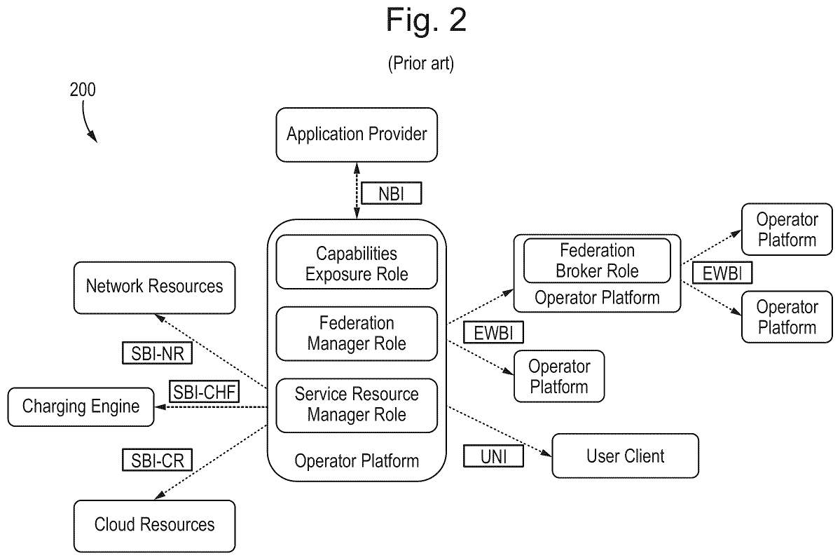

FIG. 2 depicts a GMSA OPG architecture 200 as defined in GSMA OPG.02 (URL: https://www.gsma.com/futurenetworks/wp-content/uploads/2021/07/GSMA-OPG-Telco-Edge-Requirements-2021.pdf), the contents of which are incorporated herein in their entirety.

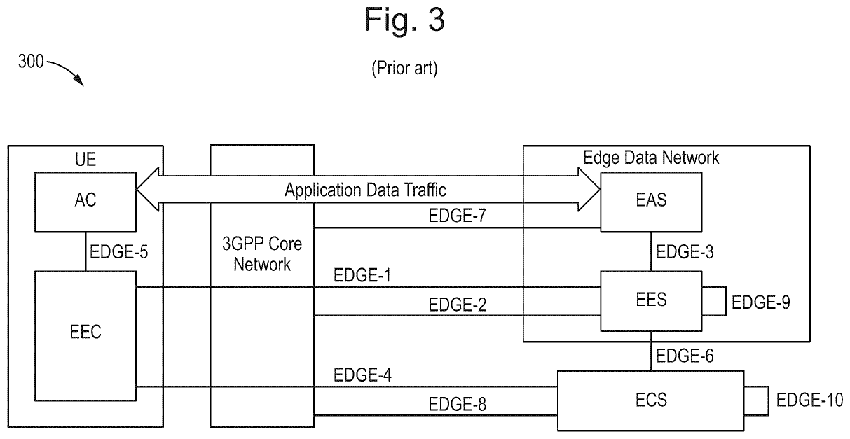

FIG. 3 depicts an application layer functional model, and in particular an EDGEAPP architecture 300, for an edge enablement layer as outlined in 3GPP TS 23.558 v17.4.0.

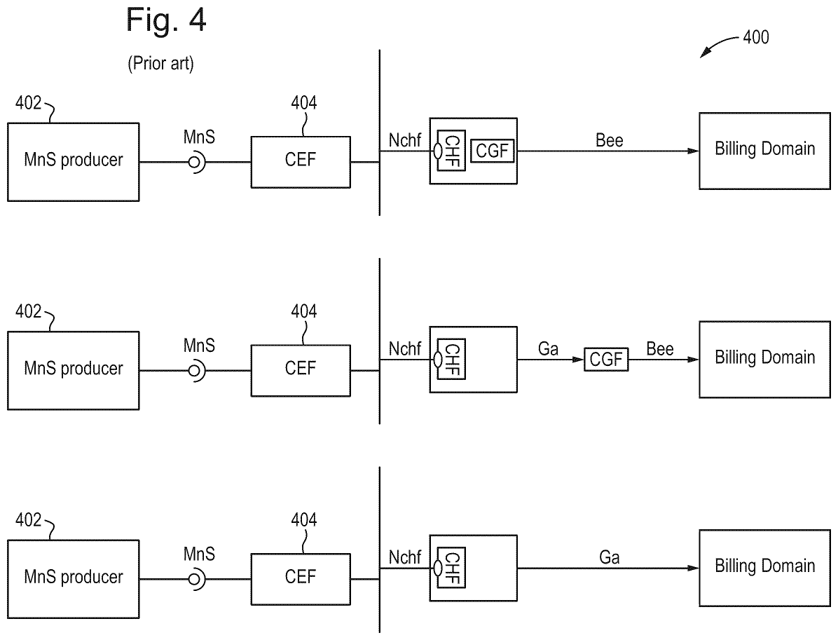

FIG. 4 depicts a converged charging architecture 400 with a MnS producer 402 enabled by a CEF 404.

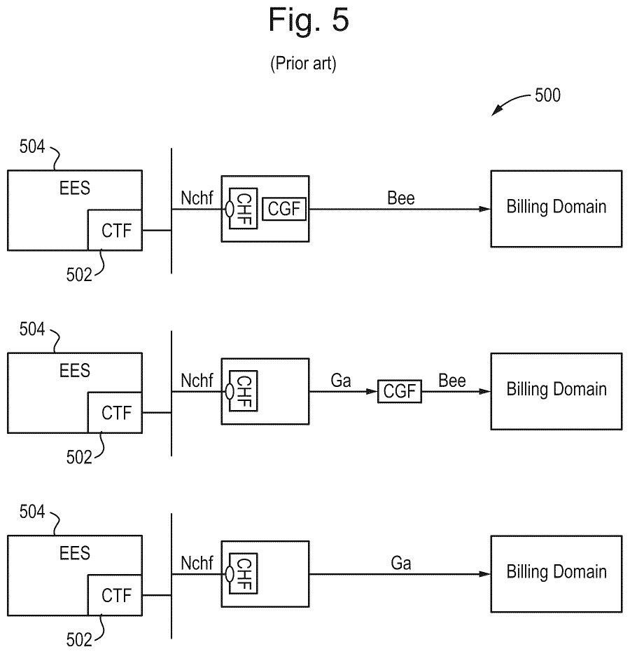

FIG. 5 depicts a further converged charging architecture 500 with a CTF 502 embedded in, i.e. integrated with, an EES 504.

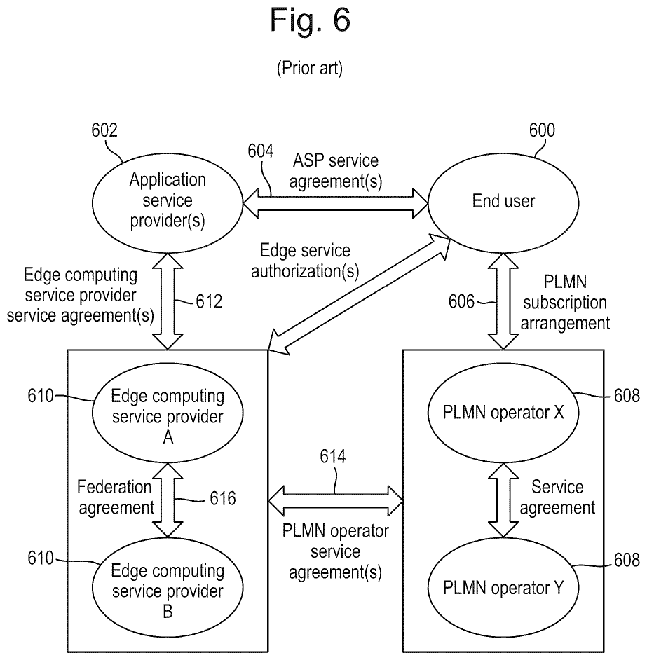

Based on 3GPP TR 23.700-98 v1.1.1, the relationships involved in edge computing services for federated service use cases is shown in FIG. 6.

FIG. 6 depicts relationships involved in edge computing services during federation and roaming.

An end user 600 is a consumer of the applications provided by the ASP 602. The end user 600:
may have an ASP service agreement 604 with one or more ASPs 602;
has a PLMN subscription arrangement 606 with a PLMN operator 608, e.g. a Home Public Land Mobile Network (HPLMN). The user equipment apparatus used by the end user may register on the HPLMN network and a network of its roaming partners; and
may have authorization to access edge services of one or more ECSPs 610.

The ASP 602 consumes the edge management services (e.g., infrastructure and/or platform services) provided by the ECSP 610 or the PLMN management service producer 608. The ASP 602 may have an edge computing service provider service agreement 612 with the one or more ECSPs 610.

The PLMN operator 608 provides connectivity between the end user 602 and the edge services provided by the ECSP 610. The PLMN operator 608:
may have a PLMN operator service agreement 614 with the one or more ECSPs 610; and
may have a service agreement for roaming including agreements for Edge Computing services, and/or federation with a single or multiple PLMN operators.

The one or more ECSPs 610 provides edge services and:
may have service agreements 614 with one or more PLMN operators 408 to provide edge computing support; and
may have a federation partnership/agreement 616 to share edge services with one or more ECSPs 610.

The ECSP(s) 610 and the PLMN operator(s) 608 belong to the same organization.

Multi-access edge computing (MEC) Federation is discussed in ETSI GR MEC035, which covers inter-MEC system coordination and can be defined as a federated model of MEC systems enabling shared usage of MEC services and applications.

In 3GPP, the federation corresponds to the shared usage of EES and/or EAS services and resources. Such federation in both MEC and EDGEAPP scenarios covers the coordination required among edge/cloud platforms for the following cases:
edge node sharing;
same edge service deployed in two or more platforms; and
different edge services/applications deployed in different platforms but with a “partner” or “dependency” relationship.

In some federation scenarios, a change of the user equipment apparatus mapping to a different edge/cloud service area may lead to either service roaming (i.e., changing of an application server or EAS or MEC service), and/or network roaming (i.e., a change of the underlying network). The present disclosure addresses the service roaming aspects. The following aspects of federation are discussed with respect to edge services.

In the first case, a federated EAS service (using partner EAS in the EDNs of other ECSPs) is described: For the EAS to provide services (weather, transportation, maps, etc.) in partnership with other EASs, EAS context processing and federated EAS support may be required at edge-compatible layers. When Application Context Relocation (ACR) occurs due to user equipment apparatus mobility, a method of rearranging the federated EAS context may be required to provide continuous service of the federated EAS. In addition, there may be a need for a method for finding an EAS that provides a federated EAS service within the EDN in which the user equipment apparatus has moved.

In the second case, edge services spanning multiple ECSPs are described. According to 3GPP TR 23.700-98 v.1.1.1, an edge service or an EAS (e.g., a V2X server) can be provided via different EDNs deployed by different respective ECSPs. Each ECSP may not have the required infrastructure to install the EAS in every EDN due to financial, regulatory and operation constraints. It is assumed that a user equipment apparatus can access the same edge service provided by respective different EASs which are registered to respective different EESs and deployed by respective different ECSPs, which have a service level agreement to share edge services. These ECSPs can deploy EESs to serve different PLMNs or different coverages of a given PLMN. A typical example of such a scenario is depicted in FIG. 4.6-1 of 3GPP TR 23.700-98 v.1.1.1.

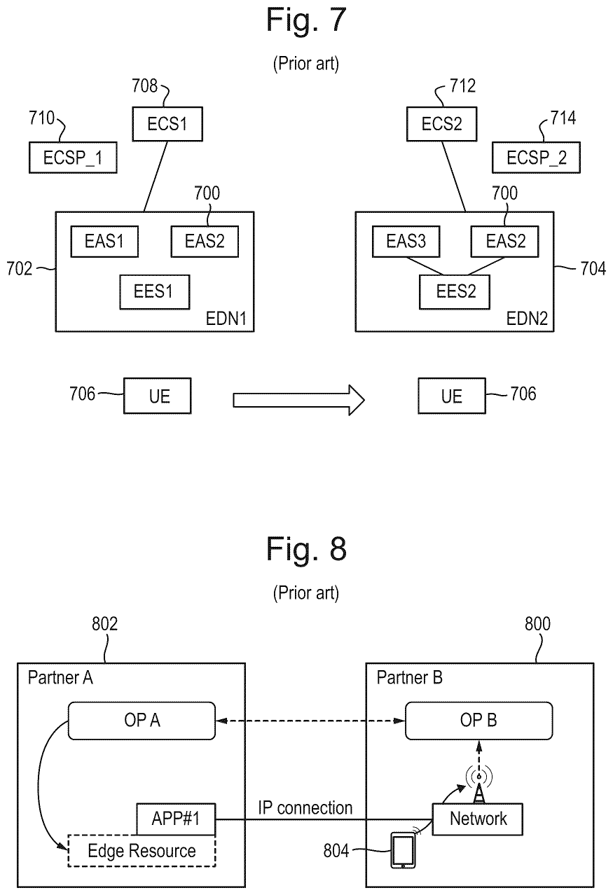

FIG. 7 depicts an EAS deployed by different ECSPs, as described in 3GPP TR 23.700-98 v.1.1.1, in accordance with the second case.

A first EAS 700 resident in a first EDN 702 and a second EDN 704 provide the same service. A user equipment apparatus 706 may be configured with a first ECS configuration information 708 (e.g., if the user equipment apparatus 706 is a subscriber of a first ECSP 710). A second ECS configuration information 712, deployed by a second ECSP 714 (a partner of the first ECSP 710), may also be needed to be provisioned to the user equipment apparatus 706 when the apparatus is out of the service area of the second EAS 700 in the first ECSP 710 and cannot find a suitable EES within the first ECSP 710 to discover and connect to the first EAS 700. The same issue exists when the first EAS 700 becomes unavailable due to other reasons, e.g. overload, or in cases where the first ECSP 710 does not deploy the first EAS 700 at all, and instead relies on the partner second ECSP 714 to provide the edge service. Besides, the user equipment apparatus 706 may have already accessed the first EAS 700 in the first EDN 702 and is getting service from the first EAS 700. In that case, it is necessary to support service continuity due to user equipment apparatus mobility when the apparatus moves out of the service area of the first EAS 700 in the first EDN 702 and transfers, e.g. goes to, the service area of the first EAS 700 in the second EDN 704.

In a third case, edge node sharing across ECSPs is described. Following from, i.e. based on, OPG.02 CR1001 Operator Platform Telco Edge Requirements, the edge node sharing scenario has been identified in GSMA OPG.02 CR1001 Operator Platform Telco Edge Requirements, clause 3.3.5.

FIG. 8 depicts this edge node sharing scenario between a first operator platform (OP) 800 and a second OP 802. In this example, OP may refer to the ECSP or other operator platform.

The first OP 800 deploys an application in the second OP 802 (i.e., the partner OP). The first OP 800 wants to scale its services for the region covered by the second OP 802 by using the edge infrastructure of the second OP 802.

In this example, a user (and user equipment apparatus 804) belongs to the first OP 800.

If the first OP 800 finds that the most suitable application for serving the user is available in the second OP 802 (the partner OP), then the first OP 800 requests the edge computing service from the second OP 802.

The above scenarios have in common that the interactions among different ECSPs (or CSPs) are needed for supporting federated edge services (to allow for dependencies among EAS, and/or joint deployment of an EAS in more than one EDN, and/or for edge node sharing). The charging for such services is a complex task that needs to be specified, since it requires interaction among ECSPs and mobile network operators (MNOs). The present inventors have realized that a problem to be solved is that of how to charge the end user for a federated service (among two or more ECSP/CSP-owned platforms) and in particular how to trigger and execute the charging for one or more user equipment apparatuses requiring a federated service (apparatuses may be unaware of the federation service). A further problem realized by the present inventors is that of how to coordinate/negotiate charging triggers among ECSPs/CSPs and how the interaction with MNO(s) is impacted.

The present application presents a solution to these problems.

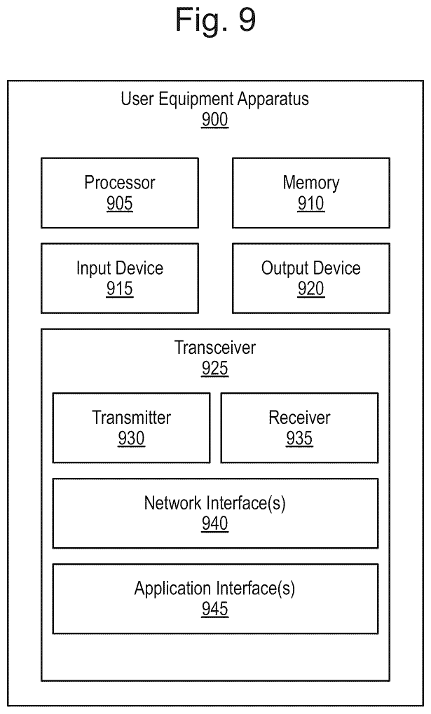

FIG. 9 depicts a user equipment apparatus (UE) 700 that may be used for implementing the methods described herein. The UE 900 is used to implement one or more of the solutions described herein. The UE 900 is in accordance with one or more of the UEs described in embodiments herein. In particular, the UE 900 is in accordance with the UEs described above. The UE 900 includes a processor 905, a memory 910, an input device 915, an output device 920, and a transceiver 925.

The input device 915 and the output device 920 may be combined into a single device, such as a touchscreen. In some implementations, the user equipment apparatus 900 does not include any input device 915 and/or output device 920. The user equipment apparatus 900 may include one or more of: the processor 905, the memory 910, and the transceiver 925, and may not include the input device 915 and/or the output device 920.

As depicted, the transceiver 925 includes at least one transmitter 930 and at least one receiver 935. The transceiver 925 may communicate with one or more cells (or wireless coverage areas) supported by one or more base units. The transceiver 925 may be operable on unlicensed spectrum. Moreover, the transceiver 925 may include multiple UE panels supporting one or more beams. Additionally, the transceiver 925 may support at least one network interface 940 and/or application interface 945. The application interface(s) 945 may support one or more APIs. The network interface(s) 940 may support 3GPP reference points, such as Uu, N1, PC5, etc. Other network interfaces 940 may be supported, as understood by one of ordinary skill in the art.

The processor 905 may include any known controller capable of executing computer-readable instructions and/or capable of performing logical operations. For example, the processor 905 may be a microcontroller, a microprocessor, a central processing unit (“CPU”), a graphics processing unit (“GPU”), an auxiliary processing unit, a field programmable gate array (“FPGA”), or similar programmable controller. The processor 905 may execute instructions stored in the memory 910 to perform the methods and routines described herein. The processor 905 is communicatively coupled to the memory 910, the input device 915, the output device 920, and the transceiver 925.

The processor 905 may control the user equipment apparatus 900 to implement the user equipment apparatus behaviors described herein. The processor 905 may include an application processor (also known as “main processor”) which manages application-domain and operating system (“OS”) functions and a baseband processor (also known as “baseband radio processor”) which manages radio functions.

The memory 910 may be a computer readable storage medium. The memory 910 may include volatile computer storage media. For example, the memory 910 may include a RAM, including dynamic RAM (“DRAM”), synchronous dynamic RAM (“SDRAM”), and/or static RAM (“SRAM”). The memory 910 may include non-volatile computer storage media. For example, the memory 910 may include a hard disk drive, a flash memory, or any other suitable non-volatile computer storage device. The memory 910 may include both volatile and non-volatile computer storage media.

The memory 910 may store data related to implement a traffic category field as described herein. The memory 910 may also store program code and related data, such as an operating system or other controller algorithms operating on the apparatus 900.

The input device 915 may include any known computer input device including a touch panel, a button, a keyboard, a stylus, a microphone, or the like. The input device 915 may be integrated with the output device 920, for example, as a touchscreen or similar touch-sensitive display. The input device 915 may include a touchscreen such that text may be input using a virtual keyboard displayed on the touchscreen and/or by handwriting on the touchscreen. The input device 915 may include two or more different devices, such as a keyboard and a touch panel.

The output device 920 may be designed to output visual, audible, and/or haptic signals. The output device 920 may include an electronically controllable display or display device capable of outputting visual data to a user. For example, the output device 920 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 920 may include a wearable display separate from, but communicatively coupled to, the rest of the user equipment apparatus 900, such as a smart watch, smart glasses, a heads-up display, or the like. Further, the output device 920 may be a component of a smart phone, a personal digital assistant, a television, a table computer, a notebook (laptop) computer, a personal computer, a vehicle dashboard, or the like.

The output device 920 may include one or more speakers for producing sound. For example, the output device 920 may produce an audible alert or notification (e.g., a beep or chime). The output device 920 may include one or more haptic devices for producing vibrations, motion, or other haptic feedback. All, or portions, of the output device 920 may be integrated with the input device 915. For example, the input device 915 and output device 920 may form a touchscreen or similar touch-sensitive display. The output device 920 may be located near the input device 915.

The transceiver 925 communicates with one or more network functions of a mobile communication network via one or more access networks. The transceiver 925 operates under the control of the processor 905 to transmit messages, data, and other signals and also to receive messages, data, and other signals. For example, the processor 905 may selectively activate the transceiver 925 (or portions thereof) at particular times in order to send and receive messages.

The transceiver 925 includes at least one transmitter 930 and at least one receiver 935. The one or more transmitters 930 may be used to provide uplink communication signals to a base unit of a wireless communications network. Similarly, the one or more receivers 935 may be used to receive downlink communication signals from the base unit. Although only one transmitter 930 and one receiver 935 are illustrated, the user equipment apparatus 900 may have any suitable number of transmitters 930 and receivers 935. Further, the transmitter(s) 930 and the receiver(s) 935 may be any suitable type of transmitters and receivers. The transceiver 925 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 925, transmitters 930, and receivers 935 may be implemented as physically separate components that access a shared hardware resource and/or software resource, such as for example, the network interface 940.

One or more transmitters 930 and/or one or more receivers 935 may be implemented and/or integrated into a single hardware component, such as a multi-transceiver chip, a system-on-a-chip, an Application-Specific Integrated Circuit (“ASIC”), or other type of hardware component. One or more transmitters 930 and/or one or more receivers 935 may be implemented and/or integrated into a multi-chip module. Other components such as the network interface 940 or other hardware components/circuits may be integrated with any number of transmitters 930 and/or receivers 935 into a single chip. The transmitters 930 and receivers 935 may be logically configured as a transceiver 925 that uses one more common control signals or as modular transmitters 930 and receivers 935 implemented in the same hardware chip or in a multi-chip module.

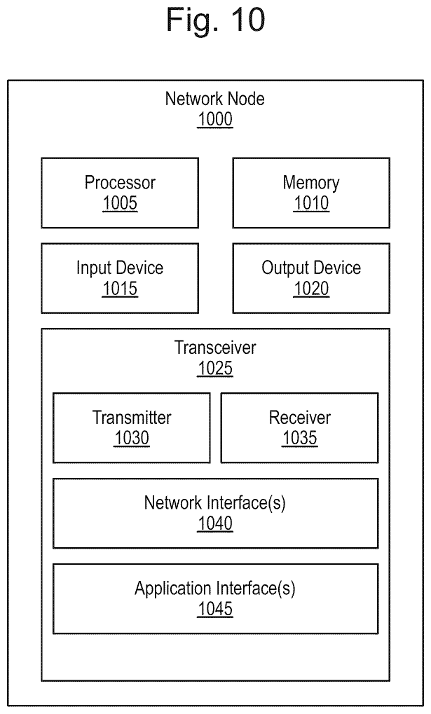

FIG. 10 depicts details of a network node 1000 that may be used for implementing the methods described herein. The network node 1000 may be one implementation of an entity in the wireless communications network, e.g. in one or more of the networks described herein. The network node 1000 may be, for example, the UE 900 described above, or a NF or application function (AF), or another entity, of one or more of the networks of embodiments described herein. The network node 1000 includes a processor 1005, a memory 1010, an input device 1015, an output device 1020, and a transceiver 1025.

The input device 1015 and the output device 1020 may be combined into a single device, such as a touchscreen. In some implementations, the network node 1000 does not include any input device 1015 and/or output device 1020. The network node 1000 may include one or more of: the processor 1005, the memory 1010, and the transceiver 1025, and may not include the input device 1015 and/or the output device 1020.

As depicted, the transceiver 1025 includes at least one transmitter 1030 and at least one receiver 1035. Here, the transceiver 1025 communicates with one or more remote units 200. Additionally, the transceiver 1025 may support at least one network interface 1040 and/or application interface 1045. The application interface(s) 1045 may support one or more APIs. The network interface(s) 1040 may support 3GPP reference points, such as Uu, N1, N2 and N3. Other network interfaces 1040 may be supported, as understood by one of ordinary skill in the art.

The processor 1005 may include any known controller capable of executing computer-readable instructions and/or capable of performing logical operations. For example, the processor 1005 may be a microcontroller, a microprocessor, a CPU, a GPU, an auxiliary processing unit, a FPGA, or similar programmable controller. The processor 1005 may execute instructions stored in the memory 1010 to perform the methods and routines described herein. The processor 1005 is communicatively coupled to the memory 1010, the input device 1015, the output device 1020, and the transceiver 1025.

The memory 1010 may be a computer readable storage medium. The memory 1010 may include volatile computer storage media. For example, the memory 1010 may include a RAM, including dynamic RAM (“DRAM”), synchronous dynamic RAM (“SDRAM”), and/or static RAM (“SRAM”). The memory 1010 may include non-volatile computer storage media. For example, the memory 1010 may include a hard disk drive, a flash memory, or any other suitable non-volatile computer storage device. The memory 1010 may include both volatile and non-volatile computer storage media.

The memory 1010 may store data related to establishing a multipath unicast link and/or mobile operation. For example, the memory 1010 may store parameters, configurations, resource assignments, policies, and the like, as described herein. The memory 1010 may also store program code and related data, such as an operating system or other controller algorithms operating on the network node 1000.

The input device 1015 may include any known computer input device including a touch panel, a button, a keyboard, a stylus, a microphone, or the like. The input device 1015 may be integrated with the output device 1020, for example, as a touchscreen or similar touch-sensitive display. The input device 1015 may include a touchscreen such that text may be input using a virtual keyboard displayed on the touchscreen and/or by handwriting on the touchscreen. The input device 1015 may include two or more different devices, such as a keyboard and a touch panel.

The output device 1020 may be designed to output visual, audible, and/or haptic signals. The output device 1020 may include an electronically controllable display or display device capable of outputting visual data to a user. For example, the output device 1020 may include, but is not limited to, an LCD display, an LED display, an OLED display, a projector, or similar display device capable of outputting images, text, or the like to a user. As another, non-limiting, example, the output device 1020 may include a wearable display separate from, but communicatively coupled to, the rest of the network node 1000, such as a smart watch, smart glasses, a heads-up display, or the like. Further, the output device 1020 may be a component of a smart phone, a personal digital assistant, a television, a table computer, a notebook (laptop) computer, a personal computer, a vehicle dashboard, or the like.

The output device 1020 may include one or more speakers for producing sound. For example, the output device 1020 may produce an audible alert or notification (e.g., a beep or chime). The output device 1020 may include one or more haptic devices for producing vibrations, motion, or other haptic feedback. All, or portions, of the output device 1020 may be integrated with the input device 1015. For example, the input device 1015 and output device 1020 may form a touchscreen or similar touch-sensitive display. The output device 1020 may be located near the input device 1015.

The transceiver 1025 includes at least one transmitter 1030 and at least one receiver 1035. The one or more transmitters 1030 may be used to communicate with the UE, as described herein. Similarly, the one or more receivers 1035 may be used to communicate with network functions in the PLMN and/or RAN, as described herein. Although only one transmitter 1030 and one receiver 1035 are illustrated, the network node 1000 may have any suitable number of transmitters 1030 and receivers 1035. Further, the transmitter(s) 1030 and the receiver(s) 1035 may be any suitable type of transmitters and receivers.

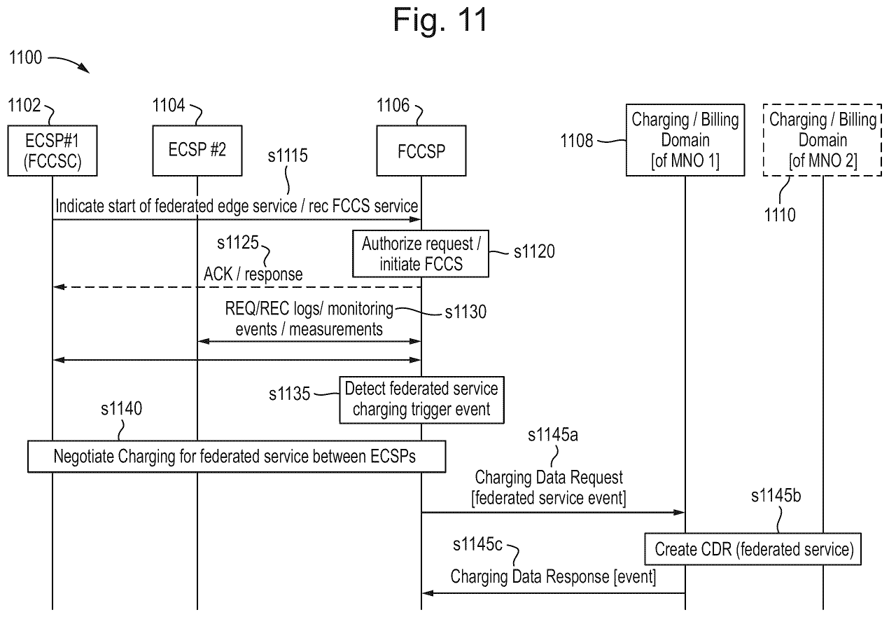

FIG. 11 depicts a procedure 1100 for coordinating charging in federated edge service scenarios. A federated service corresponds to the shared usage of EES and/or EAS services and resources. Such federation in both MEC and EDGEAPP scenarios may cover the coordination required among edge/cloud platforms for the following cases:
(A) edge node sharing,
(B) the same edge service deployed in two or more platforms, and
(C) different edge services/apps deployed in different platforms but with a “partner” or “dependency” relationship.

In some federation scenarios, the change of the UE mapping to different edge/cloud service area may lead to either service roaming (changing of app server or EAS or MEC service), and/or network roaming (change of underlying network).

The procedure 1100 involves the following entities: FCC service consumer (FCCSC) 1102 which may be comprised in a first ECSP, a second ECSP 1104, a federation charging coordination service producer (FCCSP) 1106, a first charging/billing domain entity, CHF, 1108 which may be of a first MNO, and a second charging/billing domain entity, CHF, 1110 which may be of a second MNO.

The procedure 1100 comprises the following steps.

At s1115, the FCCSP 1106 (or, in some embodiments a FCC function which can be a Federation Manager, or a Federation Broker or a functionality at one or both first and second ESCPs, or an MNO-deployed functionality at the 5GC-CP) detects a federated edge service. Such detection can be based on receiving a request like a service provisioning request for an EAS deployed by a different EDN or an EAS LCM request in edge resource sharing scenario, or a request involving multiple EASs deployed in different EDNs with dependencies. For example, in gaming applications, multiple EASs may need to be mapped to a UE, e.g. gaming engine, chat, etc. FIG. 11 depicts, by way of example, such a request being received by the FCCSP 1106 from the FCCSC 1102.

Based on the type of federation service, the detection of the federated edge service may differ.

For (A) above, the detection can be based on a EAS/EES LCM request from the consumer (ASP/end user) or from a Federated Service related notification from Federation Manager or one of the ECSPs.

For (B) above, the detection can be based on EAS LCM notification by a federation manager indicating the extension of EAS to a second ECSP platform for a given service.

For (C) above, the detection can be based on a service provisioning request which identified as federated. Such mapping of the service to two or more ECSPs can be known at the FCCSP in advance, for example, from an OAM or 3rd party.

Such detection can be based on receiving from the FCC service consumer (FCCSC) 1102 of one or more ECSPs an indication for the start of a federated service or a request/subscription to initiate the coordination service for a given federated edge service. Such request may include the ECSP entity IDs, addresses, the UE(s) for which the service applies, the area and time of interest, the slice ID/PLMN ID, and/or whether it is for single PLMN or multiple PLMNs the service. Such indication may be indirectly provided to the FCCSC 1102 from the ECSP(s) after the response to request, and may be based on either IEC or PEC scenarios as specified in 3GPP TS 32.290 v17.5.0.

At s1120, the FCCSP 1106 authorizes the request and initiates the service.

This may trigger the utilization of a CTF or CEF at one or more entities at an ECSP (e.g., at the edge platforms) or at the federation manager. Such use may enable or facilitate monitoring the different entities for charging events.

Optionally, at s1125, the FCCSP 1106 sends an acknowledgement (i.e. an ACK/response) to the FCCSC 1102.

At s1130, in the case of CEF-based charging, the FCCSP 1106 requests or subscribes to collect performance data from both the first and second ECSPs (i.e. from the MnS provisioning service producers) to identify the charging data for the federation service. Otherwise, for example, the case of CTF based charging, this step (i.e. s1130) may be omitted.

In cases where additional CTF/CEF parameterization is implemented, the FCCSP 1106 may provide configuration parameters to the involved ECSPs.

At s1135, the FCCSP 1106 decides whether to trigger the charging for the federated edge service. For this decision, the FCCSP 1106 may, at s1140, interact with one or both ESCPs (EES, ECS) to negotiate on the charging data and/or notify the involved parties on the expected charging event based on the charging data for the federation service.

At s1145a, when the charging is triggered for the federated edge service, the FCCSP 1106 configures the charging data, either based on the collected resource usage (based on the coordination) in the case of CEF-based charging, or based on the charging data from the CTF. The charging data request is sent to the first CHF 1108 to process the related charging data for CDR generation purposes.

At s1145b, the first CHF 1108 stores the received information and decides whether to store the information for future aggregation or to create a CDR related to the event. In case of a multi-PLMN scenario, the CHFs of both MNO domains, i.e.

both the first and second CHFs 1108, 1110, may jointly generate the CDR, or the first CHF 1108 may sends the CDR to the second MNO (e.g. to the second CHF 1110).

This may be performed depending on the MNO that owns the resource/sharing option.

At 1145c, the first CHF 1108 informs the CEF and FCCS on the result of the request.

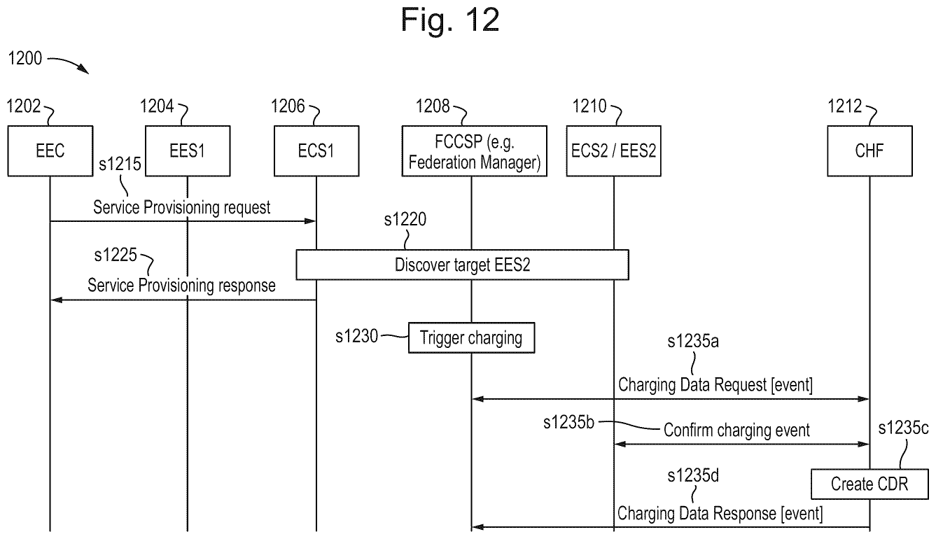

FIG. 12 depicts a procedure 1200 for charging for an edge service spanning across ECSPs/CSPs.

The procedure 1200 involves the following entities: an EEC 1202, a first EES 1204, a first ECS 1206, a FCCSP 1208, a second ECS 1210 (which in some embodiments may be a second EES), and a CHF 1212.

The procedure 1200 comprises the following steps.

At s1215, the first ECS 1206 receives request for obtaining EES information. This procedure may be triggered by one or more of the following events:
i) The EEC 1202 sends a service provisioning request to the first ECS 1206. It may be the case that the EEC 1202 has been pre-configured or has been provisioned with the address (e.g. URI) of the first ECS 1206. The request may include the UE location. For the roaming scenario, the request may also include a serving PLMN ID of the UE hosting the EEC 1202.
ii) The S-EES (i.e. the first EES 1204) sends the Retrieve EES request to the first ECS 1206 in order to identify the T-EES which has an EAS available to serve the UE.

At s1220, if the first ECS 1206 cannot or does not discover a suitable T-EES to serve the UE at the received or retrieved UE location based on the received information (e.g., all the EESs registered on the first ECS 1206 do not cover the given UE location), the first ECS 1206 discovers another ECS (i.e. in this embodiment, the second ECS 1210) which may have a suitable EES based on the information such as the UE location. Such discovery can be done via the Federation Manager or directly between the involved ECSPs ECSs.

At s1225, the first ECS 1206 sends a service provisioning response to the requester, i.e. to the EEC 1202 in this embodiment. In some embodiments, this step can be alternatively performed after step s1235, for example in the IEC scenario, or this step may be omitted.

At s1230, the FCCSP 1208 detects that a federation service is requested/provisioned and triggers the charging. In this case, the FCCSP 1208 can be deployed at Federation Manager or at an EES/ECS of one or both ECSPs. The detection can be based on processing the service provisioning request and identifying that the suitable EES/EAS will be provided by a different EDN. Based on the detection, the charging may be triggered. For the decision of the trigger, the FCCSP 1208 may, in some embodiments, negotiate with the second ECS 1210 independently or apart from the first ECS 1204.

At s1235a, the FCCSP 1208 sends a charging data request to the CHF 1212.

At s1235b, the CHF 1212 optionally confirms the request with the second ECSP (i.e. the ECSP of the second ECS 1210). This may be performed in cases where the FCCSP 1208 is part of the first ECSP (i.e. the ECSP of the first ECS 1206).

At s1235c, the CHF 1212 creates a CDR for the federated service.

At s1235d, the CHF 1212 provides the charging data response to the FCCSP 1208 and/or individually to the EES/ECS 1204, 1206, 1210 of one or both ECSPs.

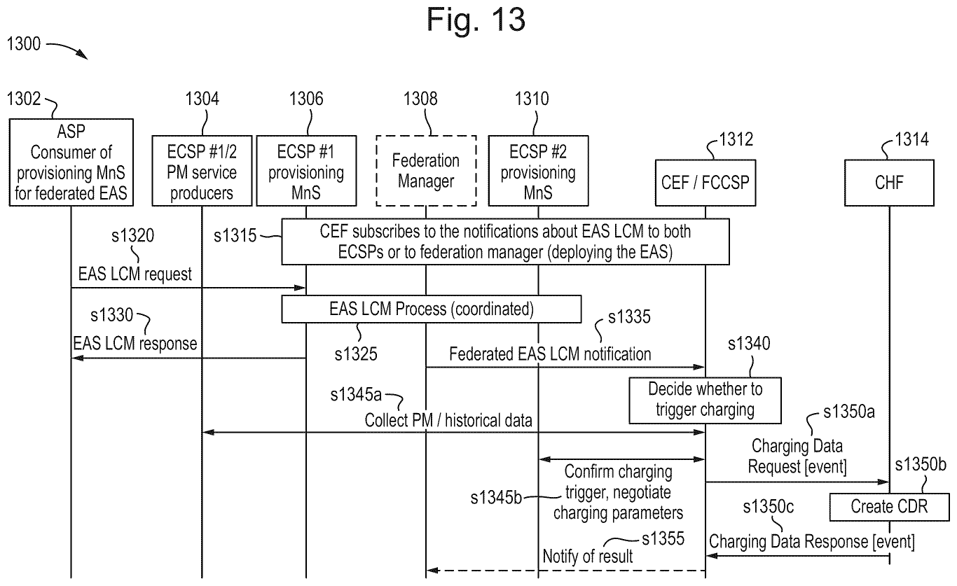

FIG. 13 depicts a procedure 1300 for charging for federated EAS LCM.

In this embodiment, the scenario is related to the EAS deployment in more than one edge/cloud platform and in particular the charging for EAS LCM in case of federated deployment.

The procedure 1300 involves the following entities: an ASP 1302 which may be a consumer of a provisioning MnS for a federated EAS, one or more service producers 1304 of a first and/or second ECSP, a first MnS producer 1306 of the first ECSP, a Federation Manager 1308, a second MnS producer 1310 of the second ECSP, a CEF 1312 (which in some embodiments may be a FCCSP), and a CHF 1314.

The procedure 1300 comprises the following steps.

At s1315, the CEF 1312 subscribes to the notifications about EAS LCM from the involved MnSs and/or the FCCSP/Federation Manager 1308. The CEF 1312 can consume the provisioning MnS (e.g. as described in more detail in TS 28.532) of one or more ECSPs to subscribe to the notifications about federated EAS LCM. Subscription to such notifications may involve, but are not limited to: notifyMOICreation, notifyMOIAttribute Valuechanges, and/or notifyMOIDeletion operations.

At s1320, the ASP 1302, i.e. the MnS consumer, sends the EAS LCM request to the first MnS producer 1306 of the first ECSP. The EAS LCM request may be done via createMOI, modifyMOIAttributes and/or deleteMOI operations (e.g. as described in TS 28.532) for the EASFunction IOC (e.g. as described in TS 28.538).

At s1325, the first MnS producer 1306 of the first ECSP, based on coordination with the Federation Manager 1308 and/or the second MnS producer 1310 at the second ECSP, jointly processes and executes the EAS LCM according to the request. For example, instantiation, upgrade, and/or deletion operations or activities may be performed.

At s1330, the first MnS producer 1306 sends the EAS LCM result (i.e. a Federated EAS LCM response) to the ASP 1302.

At s1335, the Federated Manager 1308 (or, in some embodiments, the first MnS producer 1306) sends the federated EAS LCM notification (e.g., notifyMOICreation, notifyMOIAttribute ValueChanges, or notifyMOIDeletion) to the CEF 1312.

At s1340, the CEF 1312 (or in some embodiments, the FCCSP) evaluates whether to trigger a charging event.

At s1345a, the CEF 1312 (or in some embodiments, the FCCSP) collects, from the PM MnS service producers 1306, 1310 of the corresponding ECSPs, performance data and or historical data/stats for the target EAS (to which the LCM applies).

At 1345b, optionally, the CEF 1312 (or in some embodiments, the FCCSP) confirms or negotiates the charging data for the charging event with the MnS producer(s) 1306, 1310 of the first and/or second ECSPs. This can be done via processing the collected performance data and mapping to a charging event trigger.

After the negotiation/confirmation, the charging event is triggered for the federated EAS LCM

At s1350a, the CEF 1312 (or in some embodiments, the FCCSP) generates charging data related to the EAS LCM notification and sends the charging data request, e.g. to the CHF 1314.

At s1350b, the CHF 1314 stores received information and create a CDR related to the event.

At s1350c, the CHF 1314 informs the CEF 1312 on the result of the charging data request.

At s1355, optionally, CEF 1312 (or in some embodiments, the FCCSP) notifies one or both of the MnS producer(s) 1306, 1310 and/or the Federation Manager 1308 on the result of the charging data request.

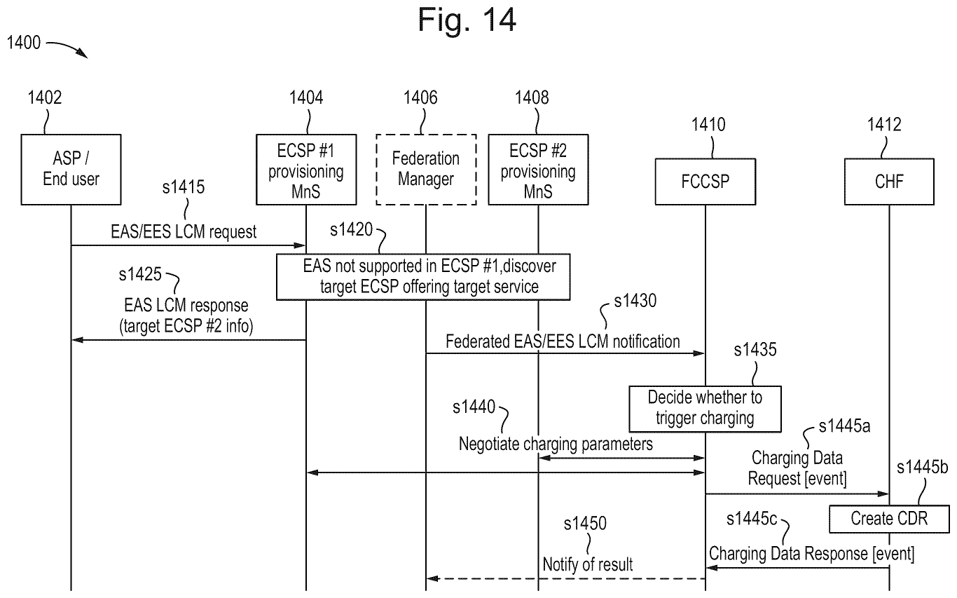

FIG. 14 depicts a procedure 1400 for charging for an edge node sharing scenario.

In this embodiment, the scenario is related to the edge resource sharing scenario, and in particular the charging of OP-B for utilizing OP-A resources/edge services. For example, the procedure 1400 may be implemented when OP-B does not have the infrastructure to provide such services in an area of interest. Such charging may be strongly coupled with the end user charging.

The procedure 1400 involves the following entities: an ASP 1402 (which may be considered to be, in some embodiments, an end user), a provisioning MnS 1404 for a first ECSP, a Federation Manager 1406, a provisioning MnS 1408 of a second ECSP, a FCCSP 1410, and a CHF 1412.

The procedure 1400 comprises the following steps.

Firstly, in some embodiments a CEF or the FCCSP 1410 may subscribe to notifications about EAS LCM from the involved MnSs and/or the Federation Manager 1406.

In any of the embodiments described herein, the FCCSC may be any appropriate entity including but not limited any entity sekected from the group consisting of: the Federation Manager, the first ECSP provisioning MnS, the second ECSP provisioning MnS, the ASP, ad the end user.

At s1415, the ASP 1402 sends an EAS/EES LCM request to the MnS 1404 of the first ECSP. The EAS/EES LCM request may be sent via createMOI, modifyMOIAttributes and/or deleteMOI operation (as described in more detail in TS 28.532) for the EASFunction IOC (as described in more detail in TS 28.538) or the EESFunction IOC.

At s1420, the first ECSP checks whether EAS/EES LCM request can be fulfilled. In the event that the first ECSP determines that such an EAS/EES is not available, and/or that the first ECSP does not have the required capability, the first ECSP discovers a target ECSP (i.e. the second ECSP in this embodiment) to provide the service/resource for the EES/EAS to meet the requirement of the ASP 1402 (or end user). Such discovery can be performed directly (e.g., the first ECSP may become a consumer of the MnS 1408 of a second ECSP) or indirectly via using a Federation Manager/Broker, such as Federation Manager 1406.

At s1425, the MnS 1404 sends the EAS LCM result to the ASP 1402, i.e. which is an MnS consumer. The EAS LCM result may include the information related to the target, second ECSP, such as but not limited to ID, address, charging model, exposure level and capabilities, EAS KPIs, and/or Slice ID/DNN/DNAI.

At s1430, the Federated Manager 1406 or the MnS 1404 sends the federated EAS LCM notification (e.g., notifyMOICreation, notifyMOIAttribute ValueChanges, or notifyMOIDeletion) to the FCCSP 1410, i.e. to the FCCS function, which in some embodiments can be also the CEF, or CTF, or an entity in one or both of the first or second ECSPs, or the Federation Manager/Broker.

At s1435, the FCCSP 1410 (which may be a FCCS/CEF) evaluates whether to trigger a charging event. This can be done, e.g. for the ECSP hosting the service, via collecting performance data as in step s1345a of the procedure 1300 described in more detail earlier above with reference to FIG. 13. The evaluation can be based on pre-configured criteria which may be provided at the federated/edge node sharing agreement between ECSPs.

At s1440, the FCCSP 1410 (which may be a FCCS/CEF) confirms and/or negotiates the charging data and/or charging parameters for the charging event with the MnS(s) 1404, 1408 of one or both of the first and second ECSPs. These parameters can be the provision of the charging model and the trigger configuration. These parameters and/or the confirmation thereof can be based on thresholds.

After the negotiation and/or confirmation of the charging data, the charging event is triggered for the federated EAS LCM. In this step, the FCCSP also acquires performance incoming data from the EES/EAS of the hosted ECSP to trigger the charging policy.

At s1445a, the FCCSP 1410 (which may be a FCCS/CEF) generates charging data related to the EAS LCM notification and sends the charging data request, e.g. to the CHF 1412.

At s1445b, the CHF 1412 stores the received information and creates a CDR related to the charging event.

At s1445c, the CHF 1412 informs the FCCSP 1410 of the result of the charging data request.

At 14450, optionally, the FCCSP 1410 notifies one or more of the MnS 1404 of the first ECSP, the MnS 1408 of the second ECSP, and/or the Federation Manager 1406 of the result of the charging data request.

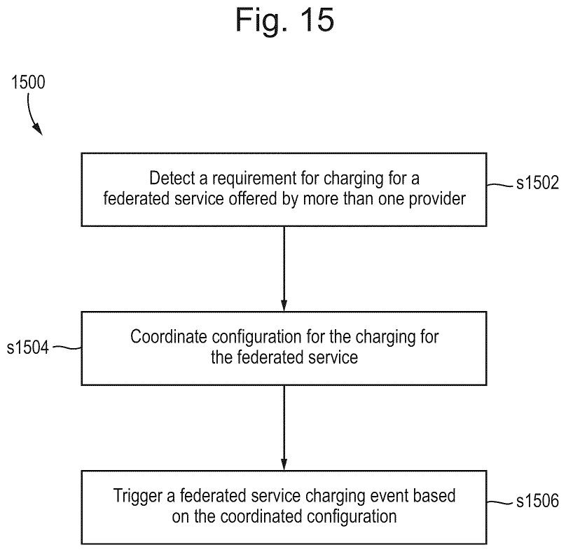

In an embodiment, there is provided a method performed at a charging control entity of a wireless network. FIG. 15 is a process flow chart depicting steps of such a method 1500. The method 1500 supports charging of a federated service. The federated service is an edge and/or cloud service offered by more than one provider. The method 1500 comprises: detecting s1502 a requirement for charging for the federated service; coordinating s1504 configuration for the charging for the federated service; and triggering s1506 a federated service charging event based on the coordinated configuration.

The method 1500 may further comprise notifying at least one of the providers of the federated service charging event.

Each of the one or more providers may be selected from the group of providers consisting of: a data network provider; a service provider, an edge service provider; and a cloud service provider.

The detecting the requirement may comprise receiving a federated service request and translating the received federated service request to a federated charging requirement.

The federated service request may comprise a service provisioning request for a first Edge Application Server, EAS, deployed by a first Edge Data Network, EDN. The service provisioning request may be received from a UE/ASP and where the UE/ASP may be provisioned with the same service by a second EAS deployed by a second EDN.

The federated service request may comprise an EAS lifecycle management, LCM, request. This may be a request for extending service provision by the EAS from one ECSP to another ECSP. The terminology “extending” service provision may refer to the EAS being deployed to second, different platform to that on which it is currently deployed. The second, different platform may be owned by a different ECSP. Extension of service provision may be implemented to ensure continuity of the application service to the extended area. This tends to be useful for cases in which some users are moving to an area outside the EDN which is not covered by the EAS.

The federated service request may comprise a request for service provision that involves multiple EASs deployed in different respective EDNs.

The method 1500 may further comprise, responsive to detecting the requirement, obtaining data for the federated service from the one or more data network providers, wherein the obtained data comprises one or data selected from the group consisting of:
a network monitoring event. The network monitoring event may correspond to performance related or failure events for a given network or network domain or slice. Such a network monitoring event can be, for example, an expected network QoS degradation in a target area, or a network failure, or a possible network resource unavailability and/or shortage which may lead to trigger a coordinated charging event.
a network parameter measurement. The network parameter measurement may be the performance data related to the ECSP platform computational resources and/or the EAS performance data and/or the performance data associated with the underlying network (e.g. radio resources or network resources). The latter may be averaged data that can be provided by an OAM of the network operator or can be acquired by the ECSPs platform.
a network data analytics parameter. The network data analytics parameter may be a predicted or statistic parameters related to the network parameters measurement above. Example of appropriate network data analytics parameters that may be used include, but are not limited to, the predicted resource utilization/load, performance, availability/failure of the involved resources, such as the computational resources, network/radio resources, edge/cloud HW/SW resources, and EAS resources.
service Application Programming Interface, API, logs information.

The coordinating the configuration may be based on negotiation of charging data between the more than one providers.

The coordinating the configuration may comprise interacting with one or more of the providers to negotiate, or cause, trigger, effect, or facilitate negotiation of, one or more charging parameters and/or one or more charging models among the more than one providers. In some embodiments, the charging control entity (e.g. the FCCSP) may interact directly with the providers for the purposes of negotiation of charging parameters. Such direct interaction may be implemented, for example, in embodiments in which the FCCSP is located at the Federation Manager or the CEF. In other embodiments, the charging control entity (e.g. the FCCSP) may interact indirectly with the providers, e.g. via a CHF.

The method 1500 may further comprise notifying and/or negotiating charging parameters between two or more of the providers or network operators associated with the federated service.

The coordinating the configuration may comprise collecting performance data related to the federated service from one or more of the providers, and wherein the negotiation uses the collected performance data.

The coordinating the configuration may comprise collecting performance data related to the federated service from one or more of the providers, and mapping the performance data to a charging event trigger, for example to an event that triggers charging.

The method 1500 may further comprise, based on the coordinated configuration, generating charging data related to the federated service, sending, to a Charging Function, CF, of the mobile network, a charging data request including the generated charging data; and receiving, from the CHF, a charging data response.

Data contained in the charging data response may depend on the type of charging. If the charging is IEC (immediate event charging), the response preferably includes the authorization for the service to start, with a number of granted units (which may be based on the request, and can be resources for the federated service). If the charging is PEC (Post Event Charging) or an update to the initial charging, the response preferably contains the result of the request (e.g., a positive or negative acknowledgment) and/or grants a quota for the service, with the reserved number of units.

The charging control entity may reside at one or more entities selected from the group of entities consisting of: a federation manager; a broker entity; a Charging Enablement Function; one or more providers' platforms; and a network operator's charging domain.

The federated service may comprise one or more services selected from the group of services consisting of: an edge computing service; an edge enablement service; an edge application server LCM service; a centralized application service; a cloud application service; a group of edge or cloud application/enablement services; and a service in an edge node sharing scenario. The group of edge or cloud application/enablement services may have dependencies. Such dependencies may be defined as the necessary interactions required for the application service to operate. For example, for a gaming app service, the different game functions are typically split across multiple servers. For example, a game engine may be implemented for game state and user input management, an in-game chat server may be implemented for communication between players, and a capture server may be implemented for capturing rendered images, encoding, and transporting them to the player's device.

In a further embodiment, there is provided a charging control entity of a wireless network. The charging control entity is arranged to provision charging of a federated service. The charging control entity comprises one or more processors arranged to: detect a requirement for charging for the federated service offered by more than one provider; coordinate configuration for the charging for the federated service; and trigger a federated service charging event based on the coordinated configuration.

The charging control entity may be a federation charging coordination service producer, FCCSP, which may reside at one or more network entities selected from the group of entities consisting of: a federation manager; a broker entity; a Charging Enablement Function; one or more providers' platforms; and a network operator's charging domain.

A novel aspect of the present disclosure is the introduction of the FCCSP (which may be a new capability of a federation manager/broker, and/or a CEF, and may reside at the ECSP or at the 5GS (e.g., the MNO core or management plane), or at a third party manager/controller). The FCCSP ma perform:
charging coordination, i.e. coordinated charging triggers and enablement, for federated edge scenarios, including scenarios involving edge node sharing, edge services being provided in more than one ECSP, and partner EASs; and
charging awareness, in federated service use cases, and negotiation among ECSPs/CSPs.

The FCCSP may be a part of the 3GPP management system in the ECSP or the PLMN responsible for the management of the federated edge services.

The above described systems and methods tend to provide a solution for multi-operator edge/cloud services (or federated services) which implements negotiation and/or coordination. Advantageously, the possibility of charging misalignments and inaccuracies when more than one ECSP/CSP is involved for the service tends to be reduced or eliminated. Advantageously, the possibility of termination or degradation of the edge service tends to be reduced or eliminated, for example in IEC scenarios.

It should be noted that the above-mentioned methods and apparatuses illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer
readable medium, which when loaded into a computer processor, Digital Signal Processor (DSP) or similar, causes the processor to carry out the hereinbefore described methods.

The described methods and apparatuses may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are used herein, and/or are known terms useful to the skilled person in understanding the methods and apparatuses disclosed herein:
3GPP—3rd Generation Partnership Project
ICT—Information and Communications Technology
ASP—Application Service Provider
HPLMN—Home Public Land Mobile Network
ECSP—Edge Computing Service Provider
ACR—Application Context Relocation
EAS—Edge Application Server
EDN—Edge Data Network
EES—Edge Enabler Server
ECS—Edge Configuration Server
OP—Operator's Platform
CSP—Cloud Service Provider
CEF—Charging Enablement Function
CHF—Charging Function
CDR—Charging Data Record
CDF—Charging Data Function
CGF—Charging Gateway Function
BD—Billing Domain
CTF—Charging Trigger Function
FCCSP—federation charging coordination service producer
LCM—Lifecycle Management
FCCSC—federation charging coordination service consumer
S- or T-EES—source or target EES
DNN—Data Network Name
DNAI—Data Network Access Identifier

1. A method performed at a charging control entity of a wireless network, the method for supporting charging of a federated service, the federated service being an edge or cloud service offered by multiple providers, the method comprising:
detecting a requirement for charging for the federated service;
coordinating configuration for the charging for the federated service; and
triggering a federated service charging event based on the coordinated configuration.

2. The method of claim 1, further comprising notifying at least one provider of the multiple providers of the federated service charging event.

3. The method of claim 2, wherein each provider of the multiple providers includes:
a data network provider;
a service provider,
an edge service provider; or
a cloud service provider.

4. The method of claim 1, wherein detecting the requirement comprises:
receiving a federated service request; and
translating the received federated service request to a federated charging requirement.

5. The method of claim 4, wherein the federated service request is a request selected from the group of requests, including:
a service provisioning request for a first Edge Application Server (EAS) deployed by a first Edge Data Network (EDN);
an EAS lifecycle management (LCM) request; and
a request for service provision that involves multiple EASs deployed in different respective EDNs.

6. The method of claim 1, further comprising, responsive to detecting the requirement, obtaining data for the federated service from the multiple providers, wherein the obtained data comprises data selected from:
a network monitoring event;
a network parameter measurement;
a network data analytics parameter; or
service Application Programming Interface (API) logs information.

7. The method of claim 1, wherein coordinating the configuration is based on negotiation of charging data between the multiple providers.

8. The method of claim 1, wherein coordinating the configuration comprises interacting with one or more of the multiple providers to negotiate one or more charging parameters or one or more charging models among the multiple providers.

9. The method of claim 7, further comprising: notifying or negotiating charging parameters between two or more of the multiple providers or network operators associated with the federated service.

10. The method of claim 7, wherein coordinating the configuration includes collecting performance data related to the federated service from one or more providers of the multiple providers, and wherein the negotiation uses the collected performance data.

11. The method of claim 1, wherein coordinating the configuration comprises:
collecting performance data related to the federated service from one or more of the multiple providers; and
mapping the performance data to a charging event trigger.

12. The method of claim 1, further comprising, based on the coordinated configuration:
generating charging data related to the federated service;
sending, to a Charging Function (CF) of the mobile network, a charging data request including the generated charging data; and
receiving, from the CF, a charging data response.

13. The method of claim 1, wherein the charging control entity resides at one or more entities, including:
a federation manager;
a broker entity;
a Charging Enablement Function;
a platform of one or more of the multiple providers; or
a charging domain of a network operator.

14. The method of claim 1, wherein the federated service comprises one or more services selected from a group of services, including:
an edge computing service;
an edge enablement service;
an edge application server LCM service;
a centralized application service;
a cloud application service;
a group of edge or cloud application/enablement services; and
a service in an edge node sharing scenario.

15. A charging control entity of a wireless network, the charging control entity arranged to provision charging of a federated service, the federated service being an edge or cloud service offered by more than one provider, the charging control entity comprising:
at least one memory; and
at least one processor coupled with the at least one memory and configured to cause the charging control entity to:
detect a requirement for charging for the federated service offered by multiple providers;
coordinate configuration for the charging for the federated service; and
trigger a federated service charging event based on the coordinated configuration.

16. The charging control entity of claim 15, wherein the charging control entity is a federation charging coordination service producer (FCCSP) residing at one or more network entities, including:
a federation manager;
a broker entity;
a Charging Enablement Function;
a platform of one or more of the providers; and
a charging domain of a network operator.

17. The charging control entity of claim 15, wherein the at least one processor is further configured to cause the charging control entity to notify at least one provider of the multiple providers of the federated service charging event.

18. The charging control entity of claim 15, wherein each provider of the multiple providers includes:
a data network provider;
a service provider,
an edge service provider; or
a cloud service provider.

19. The charging control entity of claim 15, wherein the at least one processor is further configured to cause the charging control entity to detect the requirement by:
receiving a federated service request; and
translating the received federated service request to a federated charging requirement.

20. A network entity for wireless communication, comprising:
at least one memory; and
at least one processor coupled with the at least one memory and configured to cause the network entity to:
detect a requirement for charging for a federated service, wherein the federated service is an edge or cloud service offered by multiple providers;
coordinate configuration for the charging for the federated service; and
trigger a federated service charging event based on the coordinated configuration.
